(19) United States
(12) Patent Application Publication
(10) Pub. No.: US 2012/0105437 A1
(43) Pub. Date: May 3, 2012

(54) Image Reproducing Apparatus and Image Reproducing Method

(76) Inventor: Goki Yasuda, Ome-shi (JP)

(21) Appl. No.: 13/118,079

(22) Filed: May 27, 2011

(30) Foreign Application Priority Data
Oct. 29, 2010 (JP) 2010-244521

(51) Int. Cl. G06T 15/00

(52) U.S. Cl. 345/419

(57) ABSTRACT

According to one embodiment, an image reproducing apparatus including, a depth information generation module configured to generate depth information from an input image signal, a depth adjustment module configured to adjust the depth information generated by the depth information generation module for at least part of a depth range in accordance with boundary information, a parallactic information generation module configured to generate parallactic information from the depth information adjusted by the depth adjustment module, and a parallactic image generation module configured to generate a left view point image signal and a right view point image signal in accordance with the parallactic information generated by the parallactic information generation module.

### CROSS-REFERENCE TO RELATED APPLICATIONS

This application is based upon and claims the benefit of priority from Japanese Patent Application No. 2010-244521, filed Oct. 29, 2010; the entire contents of which are incorporated herein by reference.

### FIELD

Embodiments described herein relate generally to an image reproducing apparatus and an image reproducing method.

### BACKGROUND

An image reproducing apparatus for reproducing images and an image reproducing method are in practical use, wherein depth information is found from an image signal and a three-dimensional image can be reproduced.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an image reproducing apparatus according to an embodiment;

FIG. 2 is an exemplary diagram showing an example of an image reproducing apparatus according to an embodiment;

FIG. 3 is an exemplary diagram showing an example of an image reproducing apparatus according to an embodiment;

FIG. 4 is an exemplary diagram showing an example of an image reproducing apparatus according to an embodiment;

FIG. 5 is an exemplary diagrams each showing an example of an image reproducing apparatus according to an embodiment;

FIG. 6A is an exemplary diagrams each showing an example of an image reproducing apparatus according to an embodiment;

FIG. 6B is an exemplary diagrams each showing an example of an image reproducing apparatus according to an embodiment;

FIG. 7 is an exemplary diagrams each showing an example of an image reproducing apparatus according to an embodiment;

FIG. 8A is an exemplary diagrams each showing an example of an image reproducing apparatus according to an embodiment;

FIG. 8B is an exemplary diagrams each showing an example of an image reproducing apparatus according to an embodiment;

FIG. 8C is an exemplary diagrams each showing an example of an image reproducing apparatus according to an embodiment;

FIG. 9 is an exemplary diagrams each showing an example of an image reproducing apparatus according to an embodiment;

FIG. 10 is an exemplary diagrams each showing an example of an image reproducing apparatus according to an embodiment;

FIG. 11 is an exemplary diagrams each showing an example of an image reproducing apparatus according to an embodiment;

FIG. 12 is an exemplary diagrams each showing an example of an image reproducing apparatus according to an embodiment;

FIG. 13 is an exemplary diagrams each showing an example of an image reproducing apparatus according to an embodiment;

FIG. 14 is an exemplary diagrams each showing an example of an image reproducing apparatus according to an embodiment;

FIG. 15 is an exemplary diagrams each showing an example of an image reproducing apparatus according to an embodiment;

FIG. 16 is an exemplary diagrams each showing an example of an image reproducing apparatus according to an embodiment; and

FIG. 17 is an exemplary diagrams each showing an example of an image reproducing apparatus according to an embodiment.

### DETAILED DESCRIPTION

Various embodiments will be described hereinafter with reference to the accompanying drawings. In general, according to one embodiment, an image reproducing apparatus includes: a depth information generation module configured to generate depth information from an input image signal; a depth adjustment module configured to adjust the depth information generated by the depth information generation module for at least part of a depth range in accordance with boundary information; a parallactic information generation module configured to generate parallactic information from the depth information adjusted by the depth adjustment module; and a parallactic image generation module configured to generate a left view point image signal and a right view point image signal in accordance with the parallactic information generated by the parallactic information generation module.

Embodiments will now be described hereinafter in detail with reference to the accompanying drawings.

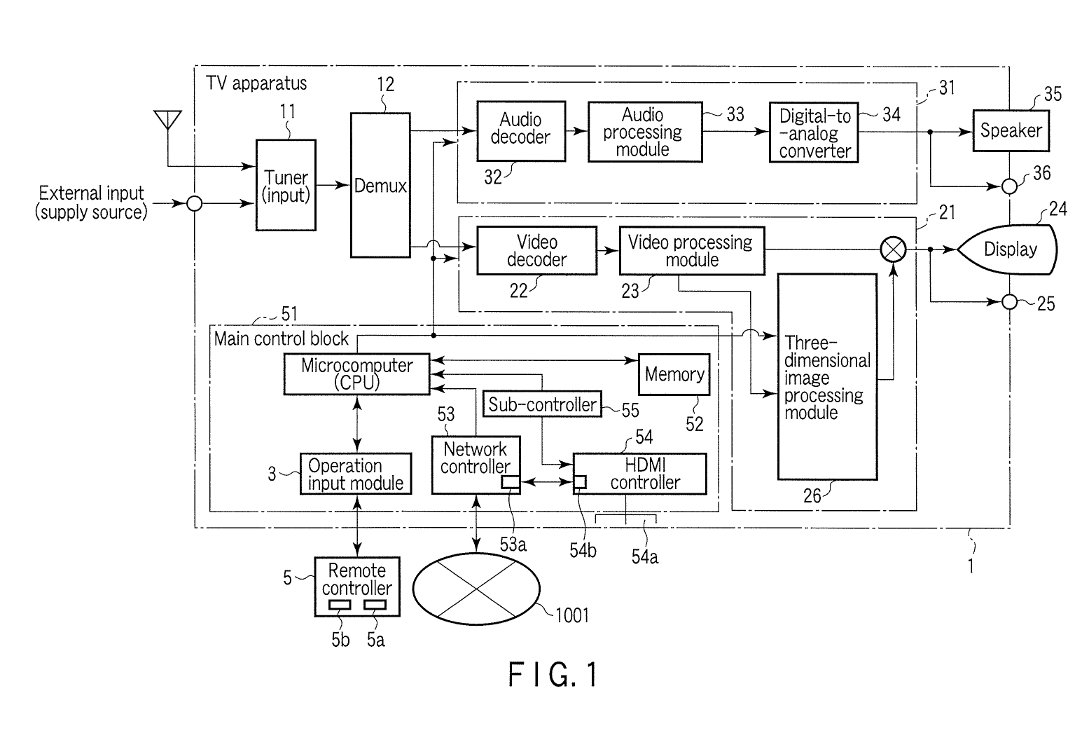

FIG. 1 shows an example of an image reproducing apparatus (e.g., a television receiver, hereinafter referred to as a TV apparatus) according to an embodiment. Elements/components described to as “module” below may be obtained by hardware or may be obtained by software using, for example, a microcomputer (processor, CPU), etc.

The TV apparatus (the image reproducing apparatus) 1 shown in FIG. 1 receives and reproduces, for example, television broadcasts supplied by space waves or wired transmission and content including sound (audio) and video (moving picture), that is, a program. The TV apparatus 1 can also reproduce content supplied via the Internet (network) 1001. The TV apparatus 1 may be configured to include a recording medium such as a hard disk (HD) and an encoder and thereby capable of recording content. Although the TV apparatus is described below by way of example in the embodiment, a tuner called a set-top box (STB) can be provided by separating a display (monitor device) and a speaker.

In the TV apparatus 1, a demux (separating module) 12 demodulates content or an external input signal acquired by a tuner/input 11 into video (moving picture) data and sound (audio) data. The tuner/input 11 can recognize whether the input video data, that is, content is a normal image (2D) signal or a three-dimensional image (3D) signal in accordance with a control signal attached to the input video signal.

The input video (the moving picture) data demodulated by the demux 12 is decoded by a video (an image) decoder 22 of a video (moving picture) processing block 21, and output as a digital video (image) signal. It goes without saying that when the content or external input signal received by the tuner/input 11 includes image and sound from, for example, a video camera, the signal does not need to be separated by the demux 12 (can be passed through) depending on the input mode of the signal.

The video (image) data decoded by the video decoder 22 is input to a video processing module 23, converted to predetermined resolution and an output mode, for example, interlace (i)/noninterlace (p) so that a display 24 at a subsequent stage can display the data, and supplied to the display 24. The video processing module 23 processes the video data so that a video output device can display the data. The output of the video processing module 23 may be output to an output terminal 25 to which, for example, an external monitor device or a projection device (projector device) can be connected.

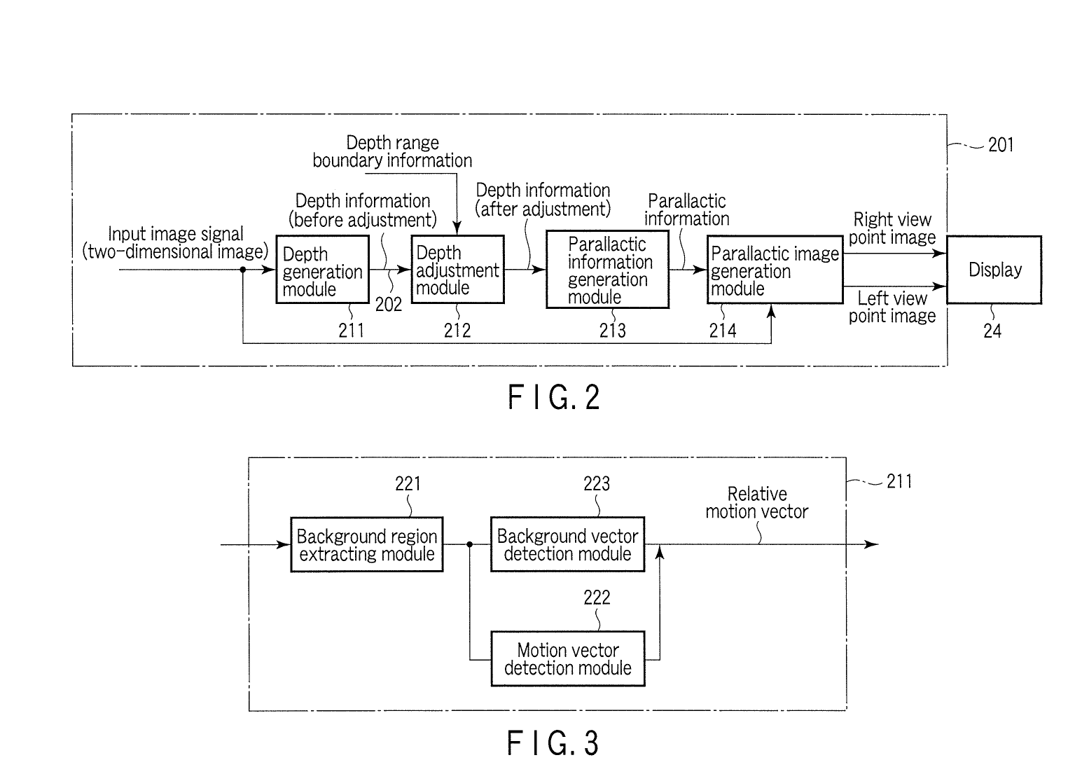

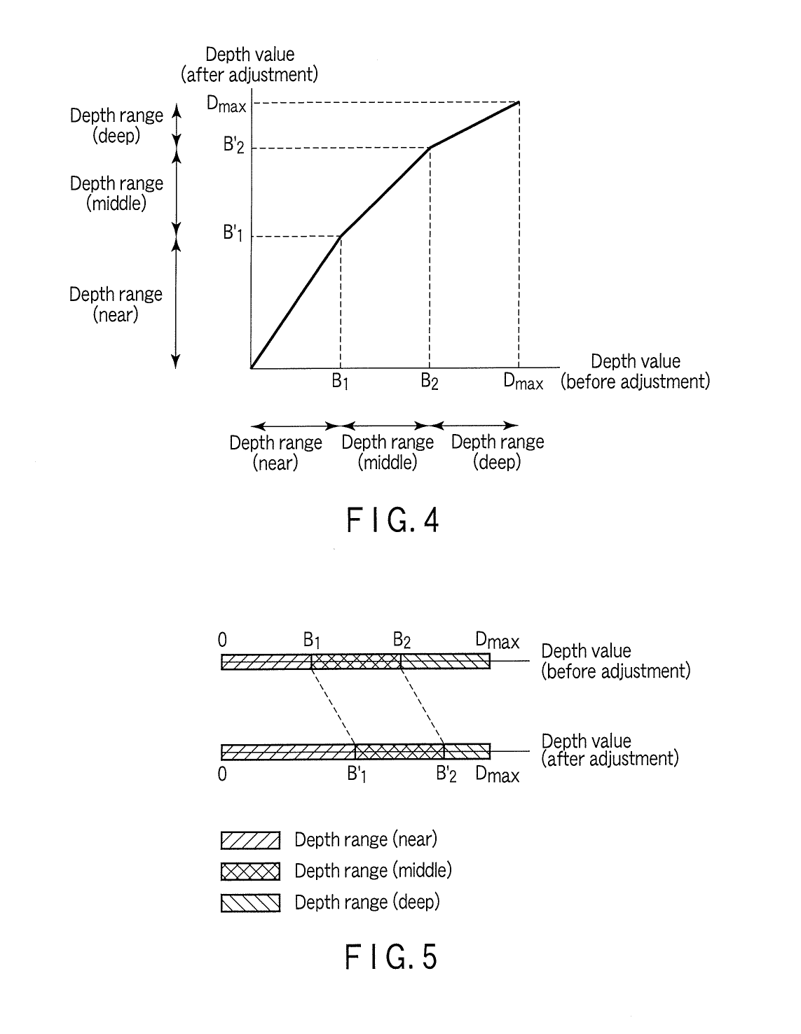

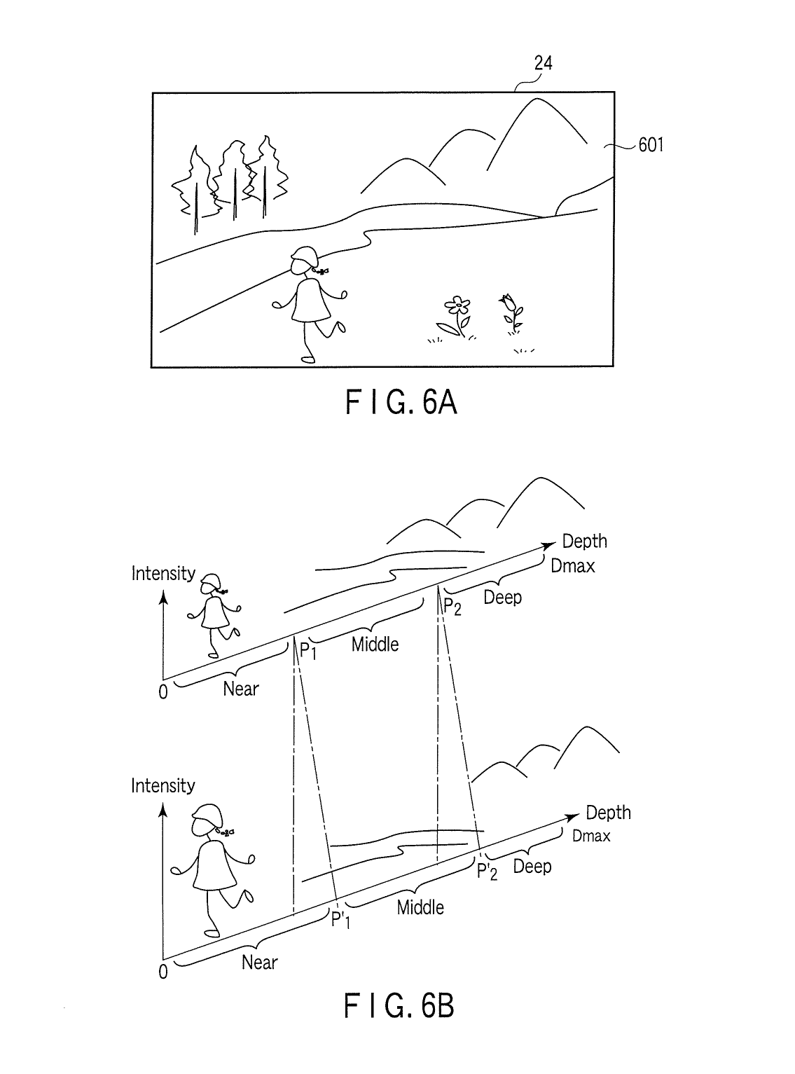

At a stage subsequent to the video processing module 23, a three-dimensional image processing module 26 is provided to obtain a three-dimensional image signal from the video signal in order to three-dimensionally display a video. The three-dimensional image processing module 26 will be described in detail later with reference to FIG. 2, FIG. 3, FIG. 4, FIG. 5, FIG. 6A and FIG. 6B.

The sound data demodulated by the demux 12 is decoded by an audio (sound) decoder 32 of an audio processing block 31, and output as a digital audio (sound) signal.

The audio signal decoded by the audio decoder 32 is input to a digital-to-analog converter 34 through an audio (sound) processing module 33. The audio (sound) processing module 33 processes the audio signal so that a sound output device can reproduce the signal. The digital-to-analog converter 34 obtains an analog audio output.

The analog audio output from the digital-to-analog converter 34 is input to, for example, a speaker 35. The output from the digital-to-analog converter 34 may further be branched to an output terminal 36 to which, for example, an audio visual (AV) amplifier can be connected.

In the TV apparatus 1, the tuner 11, the demux 12, the video processing block 21, and the audio processing block 31 are controlled by a main control block 51, and perform predetermined operations, respectively.

The main control block 51 includes, for example, a central processing module (CPU) or a microcomputer. The main control block 51 comprises, for example, at least a memory 52, a network (LAN) controller 53, and an HDMI controller 54. The memory 52 includes at least a ROM retaining an operation program, and a RAM functioning as a work memory. The network (LAN) controller 53 controls the connection with the Internet 1001, that is, the acquisition of various kinds of information from the Internet 1001 and accesses to the Internet 1001 from a user. The HDMI controller 54 controls the passage of data/control signals via Ethernet (registered trademark) in compliance with the HDMI (registered trademark) standard.

The HDMI controller 54 includes an HDMI port 54a and an HDMI port 54b. The HDMI port 54a is used for connection with external devices. The HDMI port 54b is capable of passing data and control signals to/from an HDMI port 53a of the LAN (network) control unit 53, and is also capable of forming an active HEC in conformity with the HDMI standard. The passage of the control signals and data between the HDMI port 54b of the HDMI controller 54 and the HDMI port 53a of the LAN controller 53 is controlled by the main control block 51 or by a sub-controller 55 connected to the main control block 51.

An operation input module 3 for accepting control inputs from the user is also connected to the main control block 51.

The operation input module 3 includes, for example, at least a receiving module which accepts instructions or control inputs from a channel key (button) for specifying a channel to be chosen by the tuner (input) 11, a power switch used for power on/off, or a remote controller 5. For example, a keyboard (a key operation input set) which enables the input of characters, signs, or numeric characters may otherwise be connected.

Switching between three-dimensional display and normal display is described below in connection with an example of control input by the remote controller 5.

The remote controller 5 includes a selective input module, for example, an input button (key) 5a capable of outputting a selection signal for switching between the three-dimensional display and the normal display and displaying the three-dimensional display or the normal display. The remote controller 5 can thus input, to the main control block 51, an instruction from the user to select, that is, to switch to the three-dimensional display. The remote controller 5 preferably has a setting button (key) 5b for setting the change of the sense of depth in the three-dimensional display.

If the three-dimensional display is selected by the operation of the remote controller 5, the output of the video processing module 23 is input to the three-dimensional image processing module 26 before output to the display 24 or the output terminal 25. The output is converted to a three-dimensional image signal described in detail later, and then output to the display 24 or the output terminal 25.

FIG. 2 shows an example of the three-dimensional image processing module incorporated in the TV apparatus (an image reproducing apparatus) shown in FIG. 1.

A three-dimensional image processing module 201 shown in FIG. 2 (indicated by 26 in FIG. 1) includes at least a depth generation module 211, a depth adjustment module 212, a parallactic information generation module 213, and a parallactic image generation module 214. The depth generation module 211 generates depth information from a two-dimensional image, that is, an output image signal of the video processing module 23, and outputs the depth information. The depth adjustment module 212 adjusts the depth information in accordance with depth range boundary information, and outputs the adjusted depth information. The parallactic information generation module 213 generates parallactic information from the adjusted depth information, and outputs the parallactic information. The parallactic image generation module 214 generates a right view point image and a left view point image on the basis of the two-dimensional image and the parallactic information, and outputs these images.

The two-dimensional image is input to the depth generation module 211 and the parallactic image generation module 214. The depth information and the depth range boundary information are input to the depth adjustment module 212. The adjusted depth information is input to the parallactic information generation module 213.

As shown by way of example in FIG. 3, the depth generation module 211 includes at least a background region extracting module 221, a motion vector detection module 222, a background motion vector detection module 223 and a relative motion vector detection module 224. The background region extracting module 221 extracts a background region image signal from the input video signal (two-dimensional image signal), and finds a background motion vector. The motion vector detection module 222 finds a motion vector (image motion vector) from video signals of regions other than a background region separated by the background region extracting module 221. The background motion vector detection module 223 calculates a representative motion vector from the background motion vector found by the background region extracting module 221 and the image motion vector found by the motion vector detection module 222. The relative motion vector detection module 224 finds a relative motion vector from the image motion vector found by the motion vector detection module 222 and the representative motion vector calculated by the background motion vector detection module 223. The relative motion vector detection module 224, by way of example only, subtracts, from the image motion vector found by the motion vector detection module 222, the representative motion vector calculated by the background motion vector detection module 223, and thus finds (estimates) the depth of an image included in the input image signal. The output of this relative motion vector detection module 224 is pre-adjustment depth information (FIG. 2—202).

As shown in FIG. 4, while a range (entire depth range) from the nearest point (origin) to the deepest point (Dₘₐₓ) is fixed, the depth adjustment module 212 changes a range (hereinafter referred to as a “near part”) between the origin and a depth point (range) B₁ to a depth point (range) B′₁, and changes a range (hereinafter referred to as a “middle”) between the depth point B₁ and the deepest point (Dₘₐₓ) to a depth point (range) B′₂. Here, the value (hereinafter referred to as a depth value) provided as the depth information indicates the nearest point when 0, and indicates a deeper point when higher.

In this case, the following relation is maintained in FIG. 4:

0<B₁<B′₁<B₂<B′₂<Dₘₐₓ

B₂−B₁=B′₂−B′₁.

Thus, in the example of FIG. 4, among three ranges that are roughly divided, the sense of depth of the image in the “near” range is most emphasized, and the sense of depth of the image in the “middle” range remains the same as that before adjustment. In the example of FIG. 4, the sense of depth is compressed in a range (hereinafter referred to as a deep part) between the depth point (range) B₂ and the deepest point (Dₘₐₓ). Therefore, visually, the sense of depth in the “near part” is enhanced, and the sense of depth in the “deep part” is weakened.

More specifically, in the example shown in FIG. 4, a depth range determined by a maximum depth value (Dₘₐₓ) is Dₘₐₓ equal to or more than 0 (origin). Thus, when

the boundary B₁ of the depth range between the “near part” and the “middle” before adjustment,

the boundary B₂ of the depth range between the “middle” and the “deep part” before adjustment,

the boundary B′₁ of the depth range between the “near part” and the “middle” after adjustment, and

the boundary B′₂ of the depth range between the “middle” and the “deep part” after adjustment are provided as the depth range boundary information, a post-adjustment depth value d′ relative to a pre-adjustment depth value d is found by a function f indicated by Equation (1) within a range provided with the above-mentioned depth range boundary information.

$$\begin{matrix}{d}^{′} = f ( d ) \\ = \{ \begin{matrix}\frac{{B}_{1}^{′}}{{B}_{1}} d & ( 0 \leq d < {B}_{1} ) \\ \frac{{B}_{2}^{′} - {B}_{1}^{′}}{{B}_{2} - {B}_{1}} d + ( {B}_{1}^{′} - \frac{{B}_{2}^{′} - {B}_{1}^{′}}{{B}_{2} - {B}_{1}} {B}_{1} ) & ( {B}_{1} \leq d < {B}_{2} ) \\ \frac{{D}_{max} - {B}_{2}^{′}}{{D}_{max} - {B}_{2}} d + ( {B}_{2}^{′} - \frac{{D}_{max} - {B}_{2}^{′}}{{D}_{max} - {B}_{2}} {B}_{2} ) & ( {B}_{2} \leq d \leq {D}_{max} )\end{matrix}\end{matrix} \qquad ( 1 )$$

Furthermore, each post-adjustment depth value d′ is output as depth information, and input to the parallactic information generation module 213.

FIG. 5 shows the result of the depth adjustment shown in FIG. 4 as the depth of an image displayed by the display 24. In the adjustment of the example shown in FIG. 4, the depth range is increased in the “near” range, and the depth range is decreased in the “deep” range. Therefore, visually, the sense of depth in the “near” range is enhanced, and the sense of depth in the “deep” range is weakened, as shown in FIG. 5.

The depth range in the “middle” is not changed, so that the sense of depth in the “middle” is maintained.

As schematically shown in FIG. 6B, the intensity of the image (see FIG. 6A) displayed by the display 24 is found regarding a portion within a particular depth range, for example, within the “near part” or the “middle” out of the depth ranges between the nearest point (origin) and the deepest point (Dₘₐₓ). The intensity can be partly changed to make any change in the sense of depth.

Moreover, the depth adjustment increases or decreases the depth range in accordance with the depth range boundary information. Thus, when the user specifies the depth boundary information to adjust the sense of depth, the user can intuitively make an adjustment. For example, for the depth range boundary information, the user may specify all of “B₁”, “B′₁”, “B₂”, and “B′₂”. Alternatively, predetermined fixed values may be used for “B₁” and “B₂”, and the user may specify “B′₁” and “B′₂”.

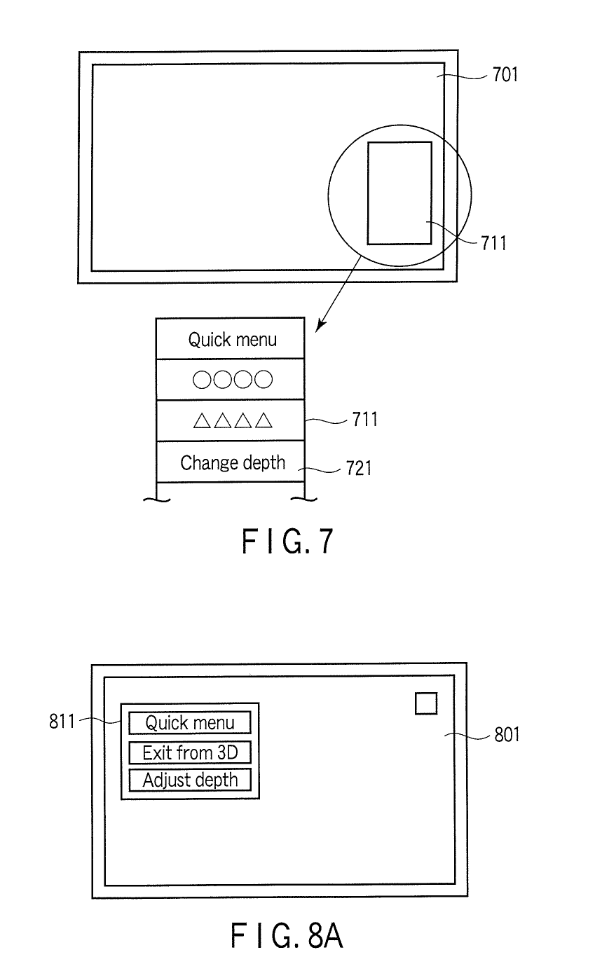

For example, when the user instructs to start the change of the depth range by the setting button (key) 5b of the remote controller 5, change modes that use intuitive expressions are prepared from the remote controller 5; for example, “enhance” set to increase the depth range between the “near part” and the “middle”, “change depth (shallower)” set to increase the depth range of the “near part”, or “change depth (deeper)” set to increase the depth range of the “middle”. For example, as shown in FIG. 7, a menu display 711 is displayed in a display 701 displayed by the display 24. A “change depth” display 721 in the menu display 711 is selected. Further, whenever the setting button 5b is switched on, the “enhance”, the “change depth (shallower)”, the “change depth (deeper)”, the “enhance”, and so on are displayed by rotation. Thus, an instruction to change the depth range separated into the three sections shown in FIG. 5 can be input.

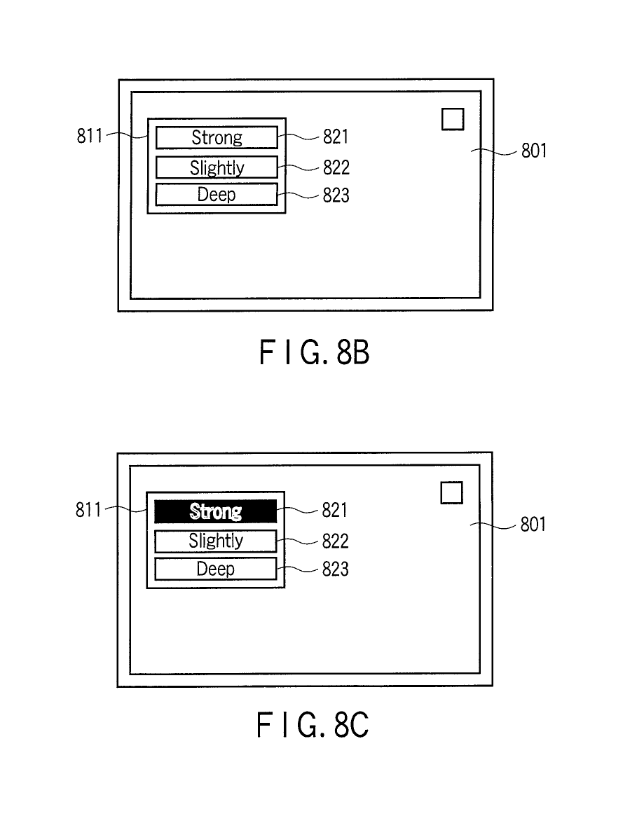

A display example is shown in FIG. 8A, FIG. 8B, and FIG. 8C. A multiple screen display can be used. A menu display 811 is displayed in a screen 801 whenever the setting button 5b of the remote controller 5 shown in FIG. 1 is switched on (FIG. 8A). A group of “change depth” buttons 821, 822, and 823 are displayed as menu bars so that a menu can be selectively input (FIG. 8B). A menu selected from the menu bars 821 to 823 by the user is determined and input (FIG. 8C).

It is known that how the sense of depth is felt (how a three-dimensional image is seen) varies with users. Thus, each change mode such as the above-mentioned “enhance”, “change depth (shallower)”, or “change depth (deeper)” may be preset by the user name of the individual user.

If the input video signal contains information such as caption information independent of the background region image and the video signal, a caption information detection module, for example, can be provided to exclude the above-mentioned depth region from the target for changing.

The parallactic information generation module 213 generates parallactic information from the adjusted depth information, and input to the parallactic image generation module 214.

If, for example, the left view point image for a left eye is set as a reference, the parallactic information is information for horizontally moving the right view point image for a right eye, and is generated in accordance with various techniques used in the generation of a three-dimensional image. In this embodiment, the parallactic information includes the above-mentioned adjusted depth information.

In accordance with the adjusted parallactic information from the parallactic information generation module 213, the parallactic image generation module 214 uses, without change, the input image as, for example, the left view point image, and horizontally shifts the pixels of the input image as the right view point image on the basis of the parallactic information (depth information), thereby generating the left view point image for the left eye and the right view point image for the right eye. Thus, the parallactic image generation module 214 outputs a video output signal to the display 24 or the output terminal 25. In accordance with the switching of inputs by the remote controller 5 or in accordance with control information that indicates an image based on the 3D (three-dimensional image) mode acquired in the tuner (input) 11, the parallactic image generation module 214 also outputs a video output signal in a format corresponding to a preset display method such as a side-by-side method, a frame-sequential method or an above-below method. It goes without saying that this applies to a display device which uses a lenticular lens requiring no deflection glasses (shutter) widely used in three-dimensional (3D) display devices.

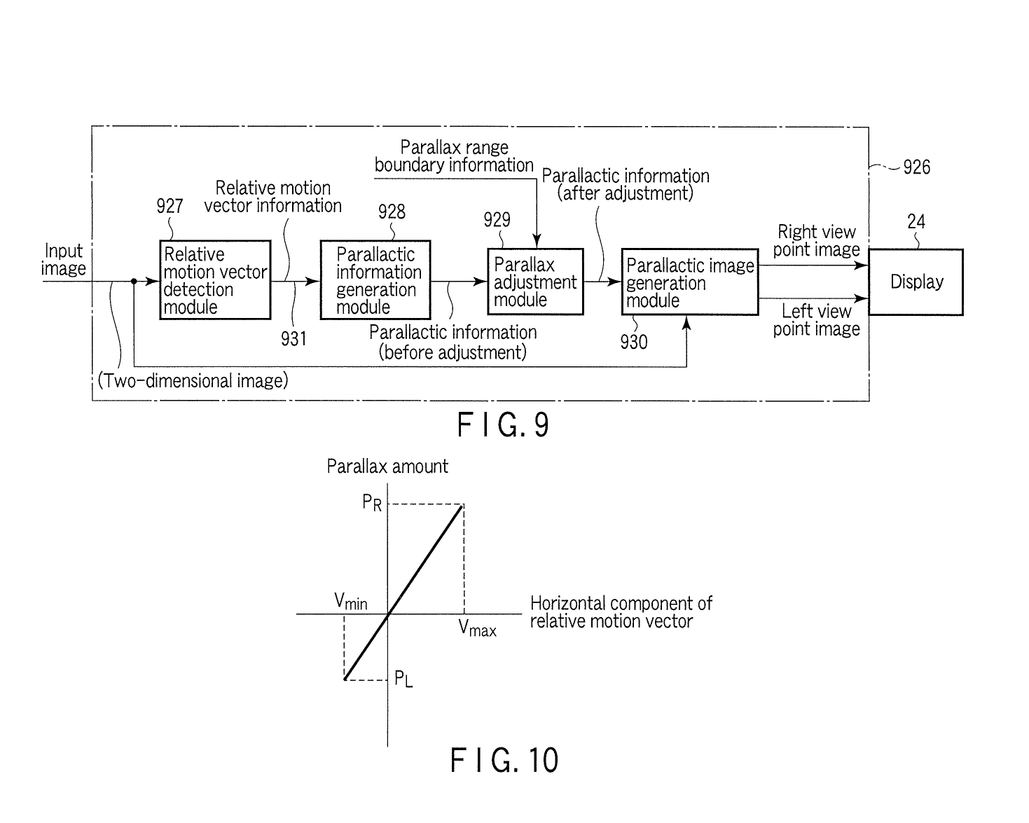

An example of another processing method applicable to the three-dimensional image processing module is shown in FIG. 9.

A three-dimensional image processing module 926 shown in FIG. 9 includes at least a relative motion vector detection module 927, a parallactic information generation module 928, a parallax adjustment module 929, and a parallactic image generation module 930. The three-dimensional image processing module 926 shown in FIG. 9 is characterized by generating a parallactic image without positively calculating the depth.

The input video signal, that is, the two-dimensional image signal is input to the relative motion vector detection module 927 and the parallactic image generation module 930.

The relative motion vector detection module 927 generates relative motion vector information from the two-dimensional image (input video image) signal, and inputs the relative motion vector information to the parallactic information generation module 928.

The parallactic information generation module 928 generates parallactic information (before adjustment) in accordance with the relative motion vector information from the relative motion vector detection module 927, and inputs the parallactic information to the parallax adjustment module 929.

The parallax adjustment module 929 adjusts the input parallactic information, and inputs the adjusted parallactic information to the parallactic image generation module 930.

As has been described with reference to FIG. 3, the relative motion vector detection module 927 separates the two-dimensional (input) image signal into a signal of the background region image and a signal of other regions, calculates a representative motion vector of the background region image from the motion vector of the two-dimensional image and the background motion vector of the background region image, and subtracts the representative motion vector from the motion vector of the two-dimensional image to calculate a relative motion vector, thus outputting the relative motion vector as relative motion vector information (FIG. 9—931).

The parallactic information generation module 928 generates the parallactic information from the relative motion vector information coming from the relative motion vector detection module 927.

For example,

a leftward maximum parallax amount P_{L}, and

a rightward maximum parallax amount P_{R} are determined in advance,

and in accordance with Equation (2), a parallax amount (parallactic information) can be calculated so that

the rightward maximum parallax amount is reached at an in-frame maximum value Vₘₐₓ of a horizontal component of the relative motion vector, and

the leftward maximum parallax amount is reached at an in-frame minimum value Vₘᵢₙ of the horizontal component of the relative motion vector

$$p = \frac{{P}_{R} - {P}_{L}}{{V}_{max} - {V}_{min}} ( v - {V}_{min} ) + {P}_{L} \qquad ( 2 )$$

### Wherein

v is the horizontal component of the relative motion vector,

p is the calculated parallax amount, and

the horizontal component of the relative vector has a positive value in the rightward direction.

FIG. 10 is a graph showing Equation (2), and the calculated parallax amount is output as the parallactic information.

The parallax adjustment module 929 adjusts the input parallactic information, and as described above, does not positively calculate the depth, but can associate the “parallax amount” with the “depth” by use of the fact that

a nearer part is indicated when the parallax amount is great leftward, and

a deeper part is indicated when the parallax amount is great rightward.

For example, a parallax range is divided into three parts including a “near part”, a “middle”, and a “deep part”, and the intensity of each part is adjusted. In this case, if the parallax range is limited by

the maximum parallax amount P_{L} for the leftward parallax range, and

the maximum parallax amount P_{R} for the rightward parallax range

that are defined in the parallactic information generation module 928, a pre-adjustment boundary of the parallax range between the “near part” and the “middle”, a pre-adjustment boundary of the parallax range between the “middle” and the “deep part”, a post-adjustment boundary of the parallax range between the “near part” and the “middle”, and post-adjustment boundary of the parallax range between the “middle” and the “deep part” are provided as parallax range boundary information.

When the above-mentioned parallax range boundary information is provided, a post-adjustment parallax amount p′ relative to a pre-adjustment parallax amount p is found by a function g in Equation (3).

$$\begin{matrix}{p}^{′} = g ( p ) \\ = \{ \begin{matrix}\frac{{P}_{1}^{′} - {P}_{L}}{{P}_{1} - {P}_{L}} P + ( \frac{{P}_{1} - {P}_{1}^{′}}{{P}_{1} - {P}_{L}} ) {P}_{L} & ( {P}_{L} \leq p < {P}_{1} ) \\ \frac{{P}_{2}^{′} - {P}_{1}^{′}}{{P}_{2} - {P}_{1}} P + ( {P}_{1}^{′} - \frac{{P}_{2}^{′} - {P}_{1}^{′}}{{P}_{2} - {P}_{1}} {P}_{1} ) & ( {P}_{1} \leq p < {P}_{2} ) \\ \frac{{P}_{R} - {P}_{2}^{′}}{{P}_{R} - {P}_{2}} P + ( {P}_{2}^{′} - \frac{{P}_{R} - {P}_{2}^{′}}{{P}_{R} - {P}_{2}} {P}_{2} ) & ( {P}_{2} \leq p \leq {P}_{R} )\end{matrix}\end{matrix} \qquad ( 3 )$$

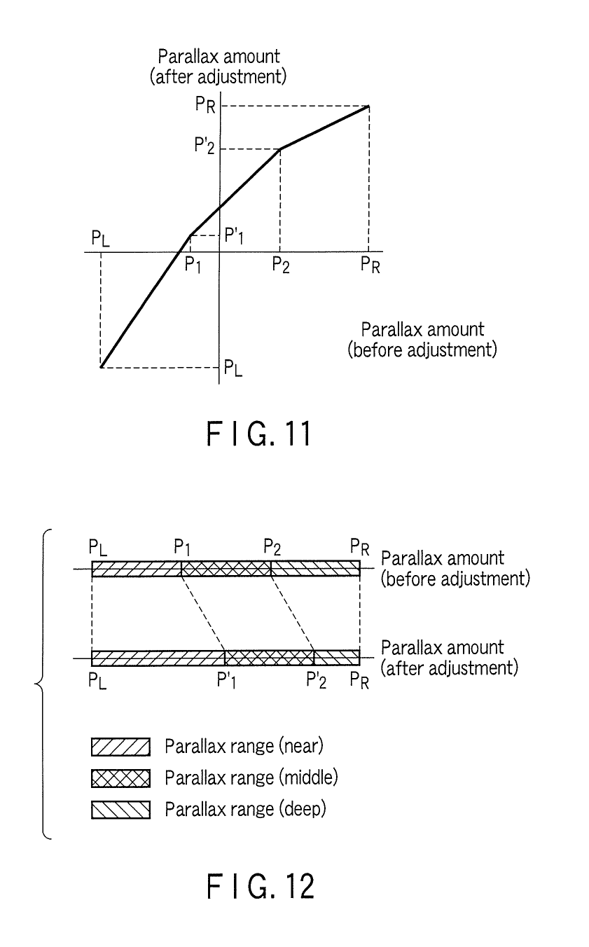

In this case, as shown in FIG. 11, the relation

P_{L}<P₁<P′₁<P₂<P′₂<P_{R},

P₂−P₁=P′₂−P′₁

is maintained for the parallax ranges before and after adjustment.

Thus, as apparent from FIG. 11, the parallax range adjustment using of Equation (3) increases the parallax range of the “near part” and decreases the parallax range of the “deep part”.

As a result, visually, the sense of depth in the “near part” is enhanced, and the sense of depth in the “deep part” is weakened. The parallax range of the “middle” does not change, so that the sense of depth in the middle is maintained.

That is, the result of the parallax range adjustment shown in FIG. 12 provide the parallax range similar to the depth adjustment shown in FIG. 4. FIG. 12 shows the result of the parallax range adjustment shown in FIG. 11 as the sense of depth in the image displayed by the display 24.

Moreover, the adjustment of the parallax range increases or decreases the parallax range in accordance with the parallax range boundary information. Thus, when the user specifies the parallax range boundary information to adjust the sense of depth, the user can intuitively make an adjustment. For example, for the parallax range boundary information, the user may specify all of “P₁”, “P₂”, “P′₁”, and “P′₂”. Alternatively, predetermined fixed values may be used for “P₁” and “P₂”, and the user may specify “P′₁” and “P′₂”.

In accordance with the adjusted parallactic information from the parallax adjustment module 929, the parallactic image generation module 930 uses, without change, the input image as, for example, the left view point image, and horizontally shifts the pixels of the input image as the right view point image on the basis of the parallactic information (depth information), thereby generating the left view point image for the left eye and the right view point image for the right eye. Thus, the parallactic image generation module 930 outputs a video output signal to the display 24 or the output terminal 25. In accordance with the switching of inputs by the remote controller 5 or in accordance with control information that indicates an image based on the 3D (three-dimensional image) mode acquired in the tuner/input 11, the parallactic image generation module 930 also outputs a video output signal in a format corresponding to a preset display method such as a side-by-side method, a frame-sequential method or an above-below method. It goes without saying that this applies to a display device which uses a lenticular lens requiring no deflection glasses (shutter) widely used in three-dimensional (3D) display devices.

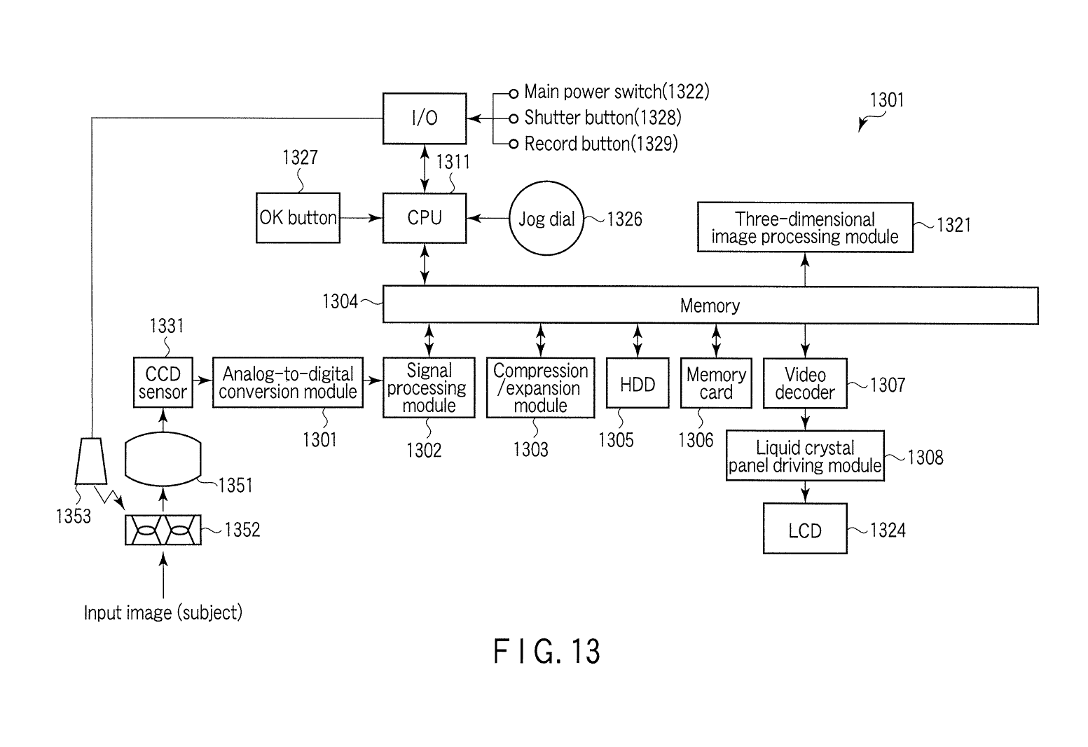

FIG. 13 shows an example of a control block of the video camera device to which the embodiment described with reference to FIG. 2, FIG. 3, FIG. 4 and FIG. 5 can be applied.

A subject image taken in from an imaging lens 1351 is formed on an imaging surface of an imaging element 1331 which is, for example a CCD sensor, and converted to an analog signal (captured image data). If a 3D expansion lens 1352 for capturing a 3D image (three-dimensional image) is set before the imaging lens 1351, the image (captured image data) output by the imaging element 1331 can be a three-dimensional image.

The analog signal (captured image data) from the imaging element 1331 is converted to a digital signal by an analog-digital (A/D) converter 1301 controlled by a CPU (Central Processing Unit) 1311, and input to a camera signal processing circuit 1302.

In the camera signal processing circuit 1302, the captured image data converted to the digital signal by the analog-to-digital converter 1301 is subjected to processing such as gamma correction, color signal separation, or white balance adjustment.

The captured image data output from the camera signal processing circuit 1302 is input to a liquid crystal panel driving circuit (LCD driver) 1308 via a video decoder 1307, and displayed on an LCD (display) 1324 by the liquid crystal panel driving circuit 1308.

In recording, the captured image data output from the camera signal processing circuit 1302 is compressed in a compressor/expander 1303, and then recorded, through a memory circuit (main memory/work memory) 1304, in a main recording medium such as a hard disk drive (hereinafter abbreviated as HDD) 1305 or an attached removable recording medium such as a memory card 1306 which is a nonvolatile memory. In the compressor/expander 1303, a still image is compressed by a known compression method such as a JPEG standard, and moving images (non-still images) are compressed by a known compression method such as an MPEG standard. A semiconductor memory called, for example, an SD card (registered trademark) or an mini-SD (registered trademark) is available as the memory card 1306.

In order to reproduce an image already recorded in the HDD 1305 or the memory card 1306, the image read from the HDD 1305 or the memory card 1306 is expanded in the compressor/expander 1303, and the expanded image is supplied to the video decoder 1307 through the memory circuit 1304. The video data supplied to the video decoder 1307 is displayed on the display (LCD) 1324 via the liquid crystal panel driving circuit 1308.

Although not shown, a recording media interface is used to pass data (compressed images) between the HDD 1305 and the memory card 1306. It goes without saying that, for example, an optical disk may be used instead of the HDD 1305. It is also possible to use a high-capacity memory card (1306) as the main recording medium.

A three-dimensional image processing module 1321 is connected to the memory circuit 1304. The three-dimensional image processing module 1321 processes a signal of a video captured as a three-dimensional image through the lens 1352.

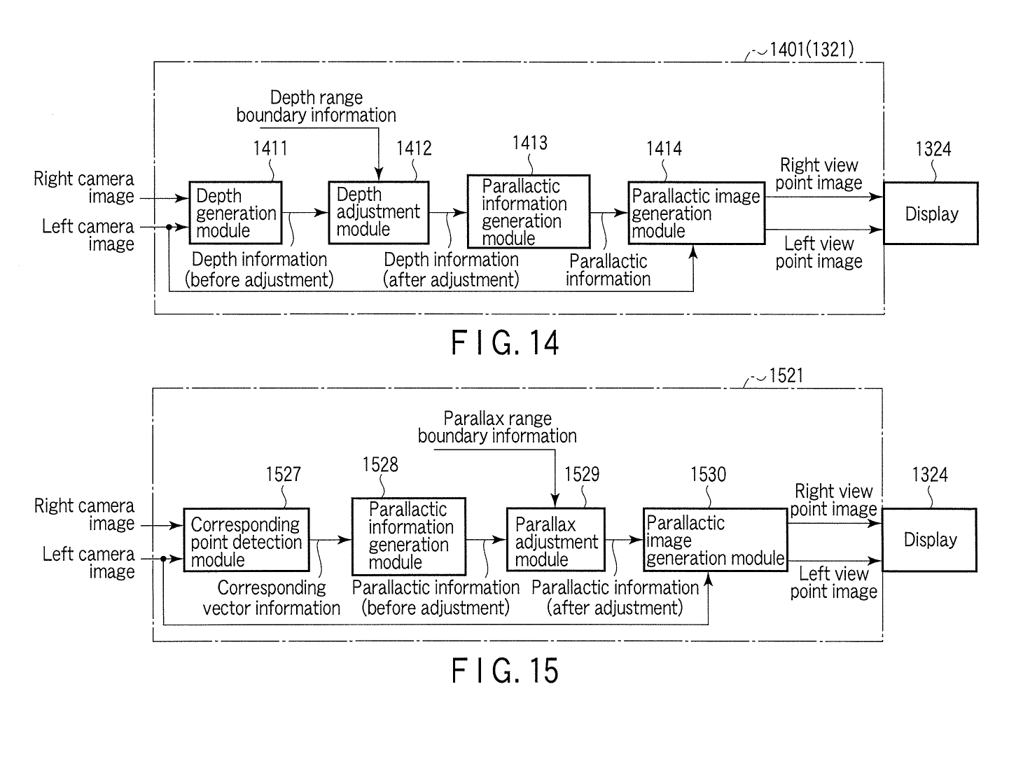

The three-dimensional image processing module 1321 is extracted and described as “1401” in FIG. 14. The three-dimensional image processing module 1401 includes at least a depth generation module 1411, a depth adjustment module 1412, a parallactic information generation module 1413, and a parallactic image generation module 1414. The depth generation module 1411 generates depth information from a right camera image and a left camera image supplied via the lens module 1352, and outputs the depth information. The depth adjustment module 1412 adjusts the depth information in accordance with depth range boundary information input by the user, and outputs the adjusted depth information. The parallactic information generation module 1413 generates parallactic information from the adjusted depth information, and outputs the parallactic information. The parallactic image generation module 1414 generates a right view point image and a left view point image on the basis of the two-dimensional image and the parallactic information, and outputs these images.

The depth generation module 1411 is different from the equivalent in the example of FIG. 2 in that the right camera image and the left camera image are input thereto. The parallactic image generation module 1414 is different from the equivalent in the example of FIG. 2 in that the left camera image is input thereto.

In the three-dimensional image processing module 1401 (1321), the depth generation module 1411 performs stereo matching by use of the right camera image and the left camera image, calculates a vector which originates from the position of a corresponding point in the left camera image and which ends in the position of a corresponding point in the right camera image, and uses the vector to generate depth information. The depth adjustment in the depth adjustment module 1412 is substantially the same as that in the example shown in FIG. 4 and FIG. 5.

The parallactic image generation module 1414 uses the left camera image as the left view point image without change. For the right view point image, the parallactic image generation module 1414 horizontally shifts the pixels of the left camera image on the basis of the parallactic information generated by the parallactic information generation module 1413, and thereby generates the left view point image for the left eye and the right view point image for the right eye. The parallactic image generation module 1414 thus outputs a video output signal to the display (LCD) 1324.

FIG. 15 shows an example of applying, as the three-dimensional image processing module in the video camera device shown in FIG. 13, the processing circuit described with reference to FIG. 9.

A three-dimensional image processing module 1521 shown in FIG. 15 includes at least a corresponding point detection module 1527, a parallactic information generation module 1528, a parallax generation module 1529, and a parallactic image generation module 1530. The corresponding point detection module 1527 detects the corresponding points from the right camera image and the left camera image supplied from the 3D lens module 1352, and generates and outputs corresponding vector information. The parallactic information generation module 1528 generates parallactic information (before adjustment) in accordance with the corresponding vector information from the corresponding point detection module 1527. The parallax generation module 1529 adjusts the input parallactic information, and outputs the adjusted parallactic information. In accordance with the adjusted parallactic information from the parallax generation module 1529, the parallactic image generation module 1530 uses, without change, the input image as, for example, the left view point image, and horizontally shifts the pixels of the input image as the right view point image on the basis of the parallactic information (depth information), thereby generating the left view point image for the left eye and the right view point image for the right eye. The parallactic image generation module 1530 thus outputs a video output signal to the display (LCD) 1324.

As the images captured by the 3D lens 1352 are two kinds of images including the left camera image and the right camera image, the corresponding point detection module 1527 calculates a vector (hereinafter, a corresponding vector) which originates from the position of a corresponding point in the left camera image and which ends in the position of a corresponding point in the right camera image, and outputs the vector as corresponding vector information.

The parallactic information generation module 1528, the parallax generation module 1529, and the parallactic image generation module 1530 are substantially similar to the equivalents in the example shown in FIG. 9 and are therefore not described in detail below.

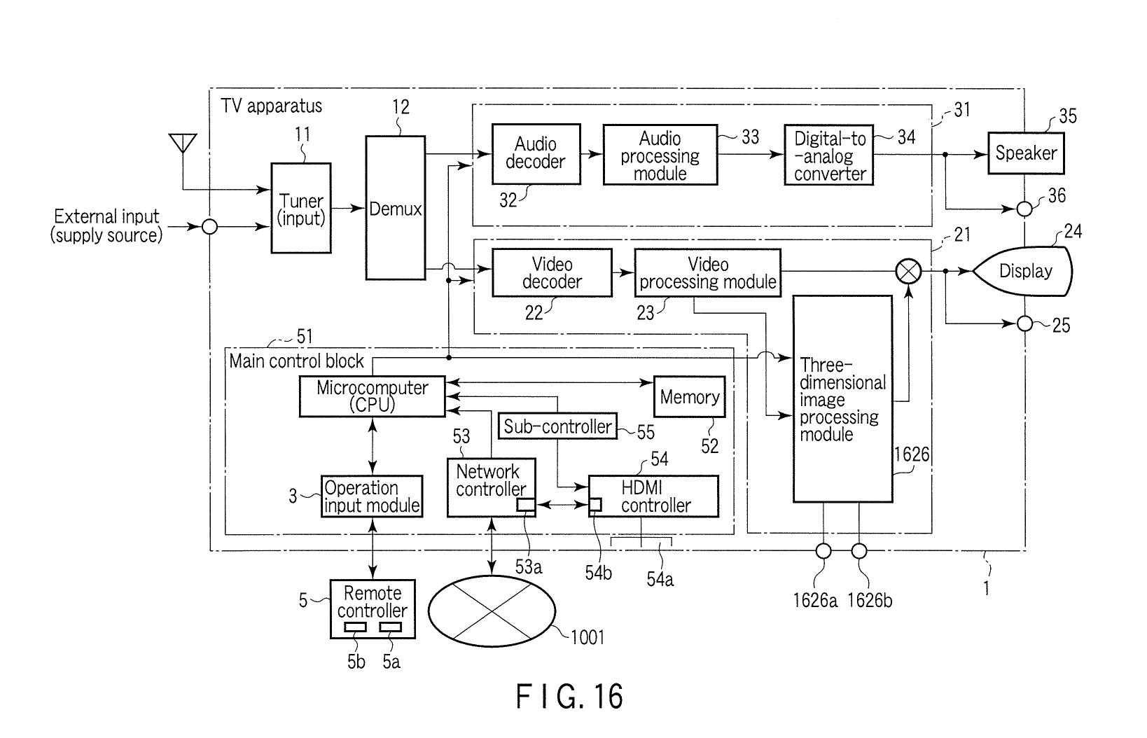

Another example of the TV apparatus (an image reproducing apparatus) is shown in FIG. 16. The basic configuration in this example is similar to that shown in FIG. 1, but is different in that the three-dimensional image processing module 1401 shown in FIG. 14 and the three-dimensional image processing module 1521 shown in FIG. 15 are incorporated in a three-dimensional image processing module 1626. Moreover, a right camera image and a left camera image of a stereo camera image signal can be input to the three-dimensional image processing module 1626 by, for example, external input terminals 1626a and 1626b.

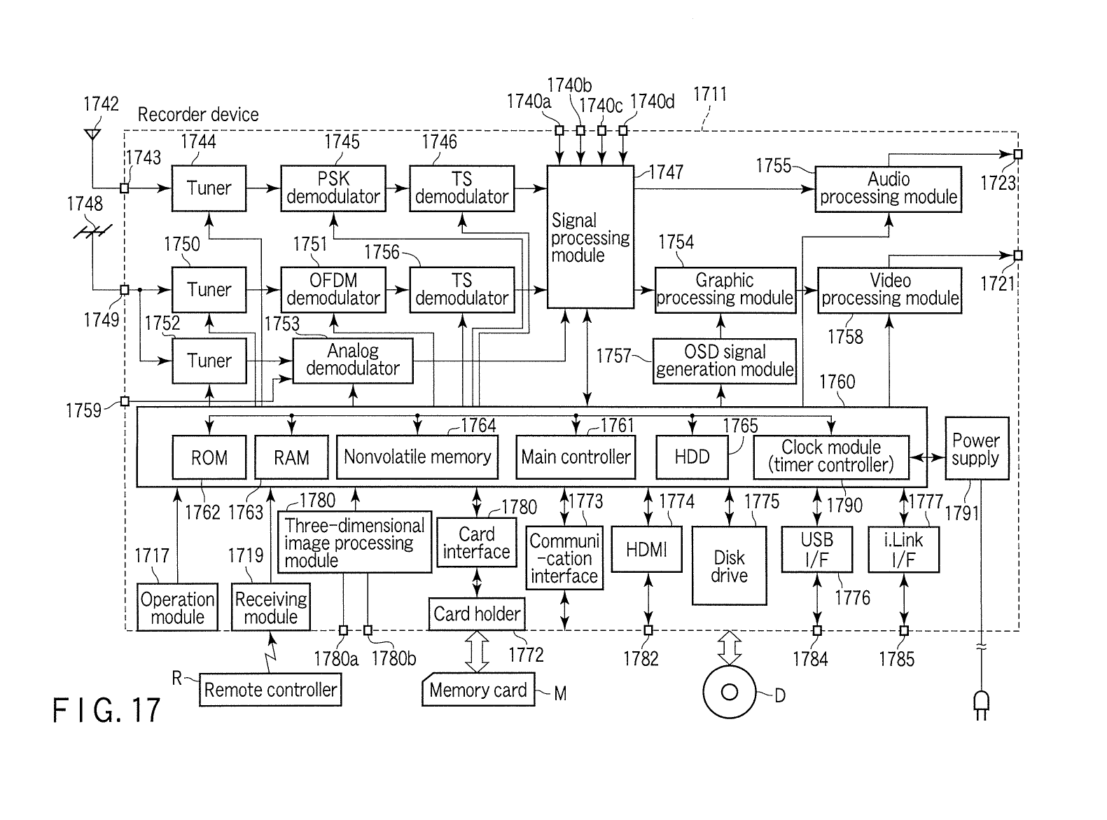

FIG. 17 shows an example of a recording/reproducing device (recorder device).

A recorder (recording/reproducing) device (recording/reproducing device) 1711 includes a video output terminal 1721 for outputting a video signal corresponding to an image signal (video data), an audio output terminal 1723 for outputting an audio signal corresponding to an audio output (audio data), an operation module 1717 for receiving a control instruction (control input) signal from the user, a remote controller receiving module 1719 for receiving an operation information (control input) signal from the user by a remote controller R, and a control block (control module) 1760.

The control block 1760 includes a main controller (main control large-scale IC (LSI)) 1761 called a CPU or a Main Processing Unit (MPU).

The control block 1760 (main controller 1761) controls the modules (elements) described below in accordance with an operation input from the operation module 1717, or a control signal (remote controller input) obtained by operation information sent from the remote controller R and received by the remote controller receiving module 1719, or information and data supplied from the outside via a network connection module (communication interface) 1773.

The control block 1760 also includes a read only memory (ROM) 1762, a random access memory (RAM) 1763, a nonvolatile memory (NVM) 1764, and an HDD 1765. The ROM 1762 retains a control program executed by the main controller 1761. The RAM 1763 provides a work area for the main controller 1761. The NVM 1764 retains various kinds of information and control information, or data such as information supplied from the outside via the network connection module 1773 and recording program information.

A card interface 1771, a network connection module (communication interface) 1773, a High-Definition Multimedia Interface (HDMI) 1774, a disk drive device 1775, and a group of a given number of interfaces such as a USB interface and an i. Link interface 1777 are connected to the control block 1760. The card interface 1771 enables reading of information from a card-like medium (memory card) M which is a semiconductor memory, and also enables writing of information into the memory card M. The disk drive device 1775 is used to read information, that is, moving image data and audio (sound) data from an optical disk D, and to write information into the optical disk. The control block 1760 functions as an external device adaptable to each interface, or as a hub (extender) or a network controller.

The card interface 1771 can read a video file and an audio file from the memory card M attached to a card holder 1772, and can also write a video file or an audio file into the memory card M.

The communication interface 1773 is connected to a LAN terminal (port) 1781, and receives control information or moving image data supplied via, for example, a portable terminal device or a mobile PC or from the remote controller R in accordance with an Ethernet standard. When a LAN-compatible hub is connected to the communication interface 1773, a device such as a LAN-compatible HDD (network attached storage [NAS] hard disk drive [HDD]), a personal computer (PC), or a DVD recorder having an HDD therein can be connected to the communication interface 1773.

For example, an unshown DVD recorder, AV amplifier, or hub is connected to the HDMI 1774 via an HDMI terminal 1782. For example, a DVD recorder or a DVD player is connected to the AV amplifier. External devices such as an AV amplifier equipped with an HDMI terminal, a PC, a DVD recorder having an HDD therein, and a DVD player can be connected to the hub. When the HDMI terminal 1782 is connected to the hub, it is possible to connect to, for example, a network such as the Internet via, for example, a broadband router, and read, reproduce, and write (record) moving image files (video data) and audio files (sound data) in PCs located on the network, unshown mobile telephones, portable terminal devices, or portable terminals.

The disk drive device 1775 reads information, that is, moving image data and audio (sound) data from the optical disk D conforming to, for example, the DVD standard or the Blu-ray standard that provides higher recording density, or records information on the optical disk D. When the loaded optical disk conforms to the CD standard, the disk drive device 1775 reads and reproduces audio (sound) data.

For example, an HDD and a keyboard accessible via the USB interface can be connected to a USB interface 1776 via an unshown hub connected to a USB port 1784, and can pass information to/from the respective USB devices. It goes without saying that a card reader/writer for mobile telephones, digital cameras and memory cards compatible with the USB interface 1776 can also be connected.

Although not shown, an external device such as an audiovisual (AV) HDD or a Digital Video Home System (D-VHS) videocassette recorder, or an external tuner or a set-top box (STB [cable television receiver]) can be serially connected to the i. Link interface 1777. The i. Link interface 1777 can pass information to/from a given device connected thereto.

Although not described in detail, it goes without saying that that a network controller compliant with the Digital Living Network Alliance (DLNA [registered trademark]) standard and an unshown Bluetooth (registered trademark), for example, are prepared in addition to the individual interfaces or instead of one or more given interfaces, and a recorder device and an HDD device or a portable terminal device capable of passing data can be connected via such equipment.

The control block 1760 includes a timer controller (clock module) 1790. The clock module 1790 can manage and record the time, and a programmed time (date and time) for programmed recording set by an input from the user, as well as information on, for example, a channel to be programmed. The clock module 1790 can always acquire “time information” called a time offset table (TOT) in a digital broadcast received via a terrestrial digital tuner 1750. This enables time management as in a device having a radio clock therein. It goes without saying that the clock module 1790 can acquire a time signal at a predetermined time every day from a predetermined channel of an analog broadcast received by a terrestrial analog tuner 1752. The clock module 1790 also serves as a timer for information for a scheduler function or a messenger function supplied from a portable terminal device. It goes without saying that the clock module 1790 can control the switching on/off (power application) of a commercial power supply by a power supply 1791 at a predetermined time specified by the scheduler function and the messenger function. That is, except when, for example, the plug is not put in and it is physically difficult to pass electricity, a secondary power supply (e.g., a direct current (DC) of 31, 24 or 5 V) supplied to the control block 1760 except for the elements having a relatively high power consumption such as a signal processing module 1747 or the HDD is generally ensured. Thus, it goes without saying that the signal processing module 1747 or the HDD 1765 is activated at a preset time.

A three-dimensional image processing module 1780 is also connected to the control block 1760. The three-dimensional image processing module 1780 is equivalent to the three-dimensional image processing module 1401 shown in FIG. 14 or the three-dimensional image processing module 1521 shown in FIG. 15. Moreover, a right camera image and a left camera image of a stereo camera image signal can be input to the three-dimensional image processing module 1780 by, for example, external input terminals 1780a and 1780b. The image signal may be input via 1740a to 1740d which can input external signals to the signal processing module 1747.

In the recorder 1711 described above, a satellite digital television broadcast signal received by a DBS digital broadcast receiving antenna 1742 is supplied to a satellite digital broadcast tuner 1744 via an input terminal 1743.

The tuner 1744 tunes in to a broadcast signal of a desired channel by a control signal from the control block 1760, and outputs, to a phase shift keying (PSK) demodulator 1745, the broadcast signal that is tuned in to.

In accordance with a control signal from the control block 1760, the PSK demodulator 1745 demodulates the broadcast signal that is tuned in to by the tuner 1744 to obtain a transport stream (TS) including a desired program, and outputs the transport stream to a TS demodulator 1746.

In accordance with a control signal from the control block 1760, the TS demodulator 1746 performs TS demodulating processing for the transport stream multiplexed signal, and outputs a digital video signal and a digital audio signal of the desired program to the signal processing module 1747. The TS demodulator 1746 outputs, to the control block 1760, various kinds of data (service information), electronic program guide (EPG) information, program attribute information (e.g., the kind of the program), and caption information which are sent by digital broadcasting and which serve to acquire the program (content).

A terrestrial digital television broadcast signal received by a digital broadcast receiving antenna 1748 is supplied to the terrestrial digital broadcast tuner 1750 via an input terminal 1749.

In accordance with a control signal from the control block 1760, the tuner 1750 tunes in to a broadcast signal of a desired channel, and outputs, to an orthogonal frequency division multiplexing (OFDM) demodulator 1751, the broadcast signal that is tuned in to.

In accordance with a control signal from the control block 1760, the OFDM demodulator 1751 demodulates the broadcast signal that is tuned in to by the tuner 1750 to obtain a transport stream including a desired program, and outputs the transport stream to a TS demodulator 1756.

Under the control of the control block 1760, the TS demodulator 1756 performs TS demodulating processing for the transport stream (TS) multiplexed signal, and outputs a digital video signal and a digital sound signal of the desired program to the signal processing module 1747. The signal processing module 1747 acquires various kinds of data, electronic program guide (EPG) information, and program attribute information (e.g., the kind of the program) which are sent by digital broadcast waves and which serve to acquire the program. The signal processing module 1747 then outputs such information to the control block 1760.

A terrestrial analog television broadcast signal received by the terrestrial broadcast receiving antenna 1748 is supplied to the terrestrial analog broadcast tuner 1752 via the input terminal 1749, so that a broadcast signal of a desired channel is tuned in to. The broadcast signal tuned in to by the tuner 1752 is demodulated to analog content, that is, an analog video signal and an analog audio signal by an analog demodulator 1753, and then output to the signal processing module 1747.

The signal processing module 1747 selectively performs predetermined digital signal processing for the digital video signals and digital audio signals respectively supplied from the PSK demodulator 1745 and the OFDM demodulator 1751. The signal processing module 1747 then outputs the processed signals to a graphic processing module 1754 and a sound processing module 1755.

Input terminals (four input terminals in the example shown in the drawing) 1740a, 1740b, 1740c, and 1740d are connected to the signal processing module 1747. These input terminals 1740a, 1740b, 1740c and 1740d respectively enable the video signals and audio signals to be input from the outside of the broadcast receiver 1711.

The graphic processing module 1754 has a function of superposing an on-screen display (OSD) signal generated by an OSD signal generation module 1757 on the digital video signal supplied from the signal processing module 1747, and outputting the superposed signals. The graphic processing module 1754 can selectively output the output video signal of the signal processing module 1747 and the output OSD signal of the OSD signal generation module 1757, and can also output a combination of these signals so that each of the signals constitute half of a screen. If an α blending parameter is set to the OSD signal output by the OSD signal generation module 1757, the OSD signal can be output in such a manner as to be superposed on a normal image display in a “semitransparent” state (in such a manner as to be able to penetrate part of a normal image signal).

When the broadcast signal includes a caption signal and a caption can be displayed, the graphic processing module 1754 superposes the caption information on the video signal in accordance with a control signal from the control block 1760 and the caption information.

The digital video signal output from the graphic processing module 1754 is supplied to a video processing module 1758. The video processing module 1758 converts the digital video signal supplied from the graphic processing module 1754 to an analog video signal. It goes without saying that, for example, an extended-projection device (projector device) and an external monitor device may be connected, as external devices, to the video output terminal 1721 connected to the video processing module 1758.

When the video signal input to the signal processing module 1747 is a video signal from the three-dimensional image processing module 1780, the video signal output from the video processing module 1758 to the output terminal 1721 includes a component subjected to the above-mentioned depth adjustment processing.

The sound processing module 1755 converts, to an analog sound signal, a digital sound signal supplied from the signal processing module 1747. Although not described in detail, it goes without saying that the sound signal (audio output) may be reproducibly output as a sound/audio output to an external speaker connected to the output terminal 1723, an audio amplifier (mixer amplifier), and a headphone output terminal prepared as one form of the output terminal 1723.

As described above, according to this suggestion, the sense of depth of the three-dimensional image that is known to vary from person to person can be set for each user.

When the range of depth to be displayed is limited to reduce the difference between a convergence distance and an adjustment distance from the perspective of safety, it is known that a phenomenon occurs in which the thickness of a subject is not three-dimensionally represented (a poorly three-dimensional image is displayed) because of a difference between an imaging distance to the subject and a distance to stereoscopic model to be displayed. However, the sense of depth can be adjusted to produce a natural three-dimensional image.

Moreover, the sense of depth of an image in part of a depth range, that is, in a particular part of the depth range can be enhanced.

The depth range can be intuitively adjusted, and there is no need for a troublesome procedure or adjustment. The sense of depth of a three-dimensional image can be easily set for each user without deteriorating the convenience of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reproducing apparatus comprising:
a depth information generation module configured to generate depth information from an input image signal;
a depth adjustment module configured to adjust the depth information generated by the depth information generation module for at least part of a depth range in accordance with boundary information;
a parallactic information generation module configured to generate parallactic information from the depth information adjusted by the depth adjustment module; and
a parallactic image generation module configured to generate a left view point image signal and a right view point image signal in accordance with the parallactic information generated by the parallactic information generation module.

2. The image reproducing apparatus of claim 1, wherein the number of pieces of boundary information used by the depth adjustment module to adjust the depth information is more than one.

3. The image reproducing apparatus of claim 1, wherein the boundary information is set in a range between a nearest point and a deepest point of the depth range.

4. The image reproducing apparatus of claim 1, wherein the depth adjustment module is configured to adjust the depth information for each of ranges obtained by dividing, in accordance with the boundary information, a range between a nearest point and a deepest point of the depth range.

5. The image reproducing apparatus of claim 4, wherein the boundary information is set in the range between the nearest point and the deepest point of the depth range.

6. An image reproducing apparatus comprising:
a motion vector detection module configured to generate motion vector information from an input image signal;
a parallactic information generation module configured to generate parallactic information from the motion vector information generated by the motion vector detection unit;
a parallax adjustment module configured to adjust the parallactic information generated by the parallactic information generation module for at least part of a depth range of a display image in accordance with boundary information; and
a parallactic image generation module configured to generate a left view point image signal and a right view point image signal in accordance with the parallactic information adjusted by the parallax adjustment module.

7. The image reproducing apparatus of claim 6, wherein the number of pieces of boundary information used by the parallax adjustment module to adjust the parallactic information is more than one.

8. The image reproducing apparatus of claim 6, wherein the boundary information is set in a range between a nearest point and a deepest point of the depth range.

9. The image reproducing apparatus of claim 6, wherein the parallax adjustment module configured to adjust the depth information for each of ranges obtained by dividing, in accordance with the boundary information, a range between a nearest point and a deepest point of the depth range.

10. The image reproducing apparatus of claim 9, wherein the boundary information is set in the range between the nearest point and the deepest point of the depth range.

11. An image reproducing method comprising:
generating depth information from an input image signal;
adjusting the generated depth information for at least part of a depth range in accordance with boundary information;
generating parallactic information from the adjusted depth information; and
generating a left view point image signal and a right view point image signal in accordance with the generated parallactic information.

12. The image reproducing method of claim 11, wherein the number of pieces of boundary information used to adjust the depth information is more than one.

13. The image reproducing method of claim 11, wherein the depth information is adjusted for each of ranges obtained by dividing, in accordance with the boundary information, a range between a nearest point and a deepest point of the depth range.

14. The image reproducing method of claim 12, wherein the boundary information is set in the range between a nearest point and a deepest point of the depth range.

15. The image reproducing apparatus of claim 1, further comprising:
a display unit configured to display an image corresponding to an image signal generated by the parallactic image generation module.

16. The image reproducing apparatus of claim 6, further comprising:
a display unit configured to display an image corresponding to an image signal generated by the parallactic image generation module.
